(19) United States
(12) Patent Application Publication
(10) Pub. No.: US 2025/0156711 A1
(43) Pub. Date: May 15, 2025

(54) METHODS AND APPARATUS TO DETECT A TEXT REGION OF INTEREST IN A DIGITAL IMAGE USING MACHINE-BASED ANALYSIS

(71) Applicant: Nielsen Consumer LLC, Chicago, IL (US)

(72) Inventors: Roberto Arroyo, Guadalajara (ES); Javier Tovar Velasco, Cigales (ES); Francisco Delgado Del Hoyo, Laguna de Duero (ES); Diego González Serrador, Valladolid (ES); Emilio Almazán, Alcorcón (ES); Antonio Hurtado, Valladolid (ES)

(21) Appl. No.: 19/006,011

(22) Filed: Dec. 30, 2024

Related U.S. Application Data
(63) Continuation of application No. 17/598,792, filed on Sep. 27, 2021, now Pat. No. 12,182,703.

(51) Int. Cl. G06N 3/08; G06V 10/25; G06V 10/82; G06V 20/62; G06V 30/413; G06V 30/414; G06V 30/416

(52) U.S. Cl. CPC G06N 3/08; G06V 10/25; G06V 10/82; G06V 20/62; G06V 30/413; G06V 30/414; G06V 30/416

(57) ABSTRACT

Methods, apparatus, systems and articles of manufacture are disclosed to analyze characteristics of text of interest using a computing system. An example apparatus includes a text detector to provide text data from a first image, the first image including a first text region of interest and a second text region not of interest, a color-coding generator to generate a plurality of color-coded text-map images, the plurality of color-coded text-map images including color-coded segments with different colors, the color-coded segments corresponding to different text characteristics, and a convolutional neural network (CNN) to determine a first location in the first image as more likely to be the first text region of interest than a second location in the first image corresponding to the second text region that is not of interest based on performing a CNN analysis on the first image and the plurality of color-coded text-map images.

### FIELD OF THE DISCLOSURE

This disclosure relates generally to computing systems, and, more particularly, to methods and apparatus to detect a text region of interest in a digital image using machine-based analysis.

### BACKGROUND

Image recognition involves computer-aided techniques to analyze pictures or photographs to determine and/or identify the content of the captured scene (e.g., the recognition of the general subject matter of the scene and/or the recognition of individual objects within the scene). Such techniques are useful in different applications across different industries. For example, retail establishments, product manufacturers, and other business establishments may take advantage of image recognition techniques of photographs of such establishments (e.g., pictures of product shelving) to identify quantities and/or types of products in inventory, to identify shelves that need to be restocked and/or the frequency with which products need restocking, to recognize and read product barcodes or textual information about the product, to assess product arrangements and displays, etc.

### BRIEF DESCRIPTION OF THE DRAWINGS

FIG. 1 is an example image collection and analysis system including an example text-map generator and an example convolutional neural network (CNN) to locate text regions of interest in images.

FIG. 2 is the example CNN of FIG. 1 structured to receive and analyze input images, and to determine locations of text regions of interest.

FIG. 3 is an illustration of an example image with multiple text regions to be analyzed by the CNN of FIG. 1.

FIGS. 4A-4D depict an example image as it is processed using examples disclosed herein to generate an example text-map and determine a location of an example text region of interest.

FIG. 5A-5D depict the example image of FIGS. 4A-4D in association with another example text-map and another example text region of interest.

FIG. 6 is an example block diagram of the text-map generator in circuit with the CNN of FIG. 1.

FIG. 7 is an example block diagram of a trainer in circuit with the CNN of FIG. 1 to train the CNN to determine locations of text regions of interest in images.

FIG. 8 depicts example images including a text region of interest identified by the CNN of FIGS. 1, 2, 6, and 7 based on teachings of this disclosure.

FIG. 9 is a flowchart representative of example machine readable instructions which may be executed to implement the trainer of FIG. 7 to train the CNN of FIGS. 1, 2, 6, and 7.

FIG. 10 is a flowchart representative of example machine readable instructions which may be executed to implement the text-map generator and the CNN of FIGS. 1, 2, 6, and 7 to determine location(s) of text regions of interest in images.

FIG. 11 is a flowchart representative of example machine readable instructions which may be executed to implement the text-map generator of FIGS. 1, 6, and 7 to generate color-coded text-maps of an example image.

FIG. 12 is a flowchart representative of example machine readable instructions which may be executed to implement the color-coding generator of FIG. 6 to parse text of an image and apply color coding based on different text characteristics.

FIG. 13 is a block diagram of an example processing platform structured to execute the instructions of FIGS. 9-12 to implement the text-map generator and/or the convolutional neural network of FIGS. 1, 2, 6, and 7.

The figures are not to scale. In general, the same reference numbers will be used throughout the drawing(s) and accompanying written description to refer to the same or like parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Examples disclosed herein employ computer vision and machine-based deep learning to detect context in which text is located (e.g., a text region of interest) in images. To identify locations of text regions of interest based on context of text, examples disclosed herein employ a CNN that is trained based on deep learning techniques to discern between different contexts in which text appears in an image. A CNN is a deep learning network relying on previously analyzed (e.g., trained) images to analyze new images. For example, if an element of interest to be analyzed and/or detected is a product logo, a CNN may be trained using a plurality of images including the product logo to understand the significant elements of the logo (e.g., the shape, color, etc.,) so that the CNN can detect, with a certain probability, that the logo appears in an image. CNN's typically perform such analysis using a pixel-by-pixel comparison algorithm. For example, a CNN may perform such analysis by extracting visual features from the image. However, text recognition performance of CNN's is substantially lower than their visual feature recognition performance due to the similarity of the visual features of text across different regions. To overcome the poor text recognition performance of CNN's and leverage their strengths in visual feature recognition performance, examples disclosed herein pre-process text in images to generate color-coded text-map images in which different color shadings are used to generate color-coded visual depictions of locations of text in an image. These color-coded text-maps operate as proxies for corresponding text when CNN's analyze the color-coded text-map images based on visual feature analysis.

In examples disclosed herein, CNN-based deep learning is used to analyze images that include text-based information or descriptions and identify text regions of interest by discerning such text regions of interest from other text regions not of interest. Techniques disclosed herein are useful in many areas including analyzing images having high-densities of text that cannot be parsed, discerned, or identified based on text characteristics with a suitable accuracy by CNN's using prior techniques. In examples disclosed herein, color-coding or color-shading locations of text in text-maps facilitate visually perceiving high-density text in an image as, for example, paragraphs of text, tables of text, groupings of relatively small-sized fonts compared to an image as a whole, etc.

In some examples disclosed herein, a source image with different text regions is analyzed by generating text data from the source image, the source image including a first text region of interest and a second text region not of interest; generating a plurality of color-coded text-map images, the plurality of color-coded text-map images including color-coded segments with different colors, the color-coded segments corresponding to different text characteristics; and determining a first location in the source image as more likely to be the first text region of interest than a second location in the source image corresponding to the second text region that is not of interest based on performing a CNN analysis on the source image and the plurality of color-coded text-map images.

As used herein, a text characteristic is defined as an aspect or trait of text characters and/or words. For example, a text characteristic may be whether the text is punctuation, whether the text is numeric, whether the text appears more than a threshold number of times, whether the text matches a dictionary of known words, or any other suitable characteristic that can be measured. As used herein, text context or context of text is defined as the underlying setting that denotes the purpose or intent for which text appears on an image. For example, the text context or context of text may represent that text is in a text region to represent an ingredients list section on a food product label, that text is in a text region to represent a nutrition facts table on a food product label, that text is in a text region to identify artistic performers on an admissions ticket, that text is in a text region to represent a store address on a sales receipt, etc.

As used herein, a text region of interest is defined as a region of text in an image that corresponds to a text context or context of text specified in a user input as a query or request for locating in an input image. For example, a user may specify in a configuration file or in an input parameter that an image analysis process should identify a text region of interest as a location of an ingredients list or a location of a nutrition facts table in an image of a food product label. Alternatively, if an example image is a sales receipt, the text region of interest may be a location of a product price or a location of a store address. In yet another example, if the input image is a product webpage for an online retailer, the text region of interest may be a location of a department list or a location of a clearance section. In examples disclosed herein, a CCN discerns between a text region of interest and other text regions that are not of interest in an input image. As used herein, text regions not of interest are regions of text in an input image not commensurate with the text context or context of text identified in user input for locating in an input image.

In examples disclosed herein, separate color-coded text-maps are generated using separate colors corresponding to different measured text characteristics. In examples disclosed herein, images of the color-coded text-maps are provided as input to a CNN to identify text context or context of text, and locate text regions of interest in a subject image.

In examples disclosed herein, color-coded text-maps represent locations of text characters based on text characteristics. Example color-coded text-maps disclosed herein are visual representations in which color highlighting, color shading, or color chips are placed at locations corresponding to text characters and/or words using color values (e.g., red, green, blue, magenta, cyan, yellow, etc.) depending on the relevance of these text characters and/or words to the text characteristics corresponding to those colors. For example, extracted text of interest matching a predetermined set of words (e.g., a dictionary containing known words or phrases that are likely to be in the requested text context such as the keyword fiber in the text context of ingredients lists) may be colored and/or highlighted with a first color. In a similar example, extracted text of interest satisfying (e.g., greater than or equal to) a numerical threshold (e.g., numerical text less than 100) may be colored and/or highlighted with a second color. In yet another example, text or words appearing in an image a number of times satisfying (e.g., greater than or equal to) an occurrence ratio threshold or an occurrence threshold may be colored and/or highlighted with a third color. In examples disclosed herein, images of the color-coded text-maps are utilized as inputs to a CNN. In examples disclosed herein, the color-coding generated for a word or text is a color highlighting, color bar, color shading, or color chip that covers the footprint or area occupied by the corresponding word or text. In this manner, a text-map becomes a visually perceptive map of locations of words or text relative to one another within the boundary limits of an image.

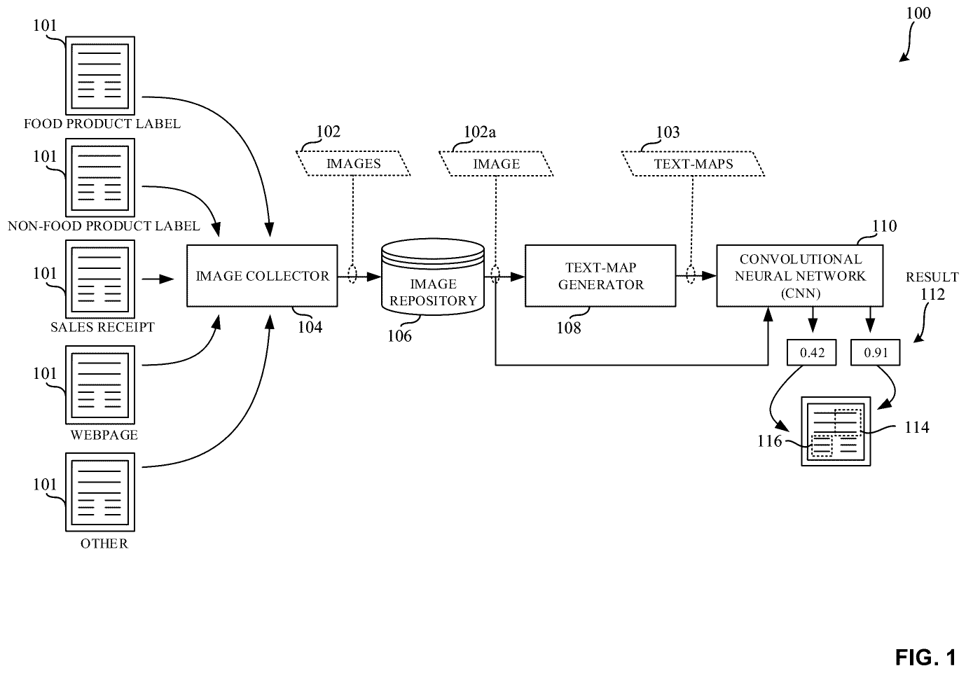

FIG. 1 is an example image collection and analysis system 100 including an example text-map generator 108 and an example convolutional neural network (CNN) 110 to locate text regions of interest in images. The image collection and analysis system 100 of FIG. 1 further includes an example image collector 104 and an example image repository 106.

In the illustrated example of FIG. 1, the image 102 represents any suitable document including text characters, words, and/or text information such as a typed document, a photograph, a handwritten document, a PDF, etc. In examples disclosed herein, the images 102 may represent any text-containing item(s) of interest including an example food product label 101, an example non-food product label 101, an example sales receipt 101, an example webpage 101, or any other item 101. In examples disclosed herein, any of the food product label 101, non-food product label 101, sales receipt 101, webpage 101, or any other item 101 may hereinafter be referred to as example image 102.

In the example of FIG. 1, the image collector 104 obtains the images 102 to be analyzed. In examples disclosed herein, the image collector 104 may be any image capturing device used to capture the images 102 (e.g., a smartphone, a tablet, a computer, a camera, a scanner, a copy machine, etc.). The image collector 104 may capture and/or otherwise obtain one of the images 102 (e.g., the food product label 102), or any number of the images 102.

In the example of FIG. 1, the image repository 106 stores the images 102 obtained by the image collector 104. For example, the image repository 106 may store the images 102 in a hardware memory. The image repository 106 may be internal or external to the image collector 104. Alternatively, in some examples disclosed herein, the image repository 106 may be implemented as cloud storage external to the image collector 104 and, such cloud storage may be accessible via wired or wireless communication.

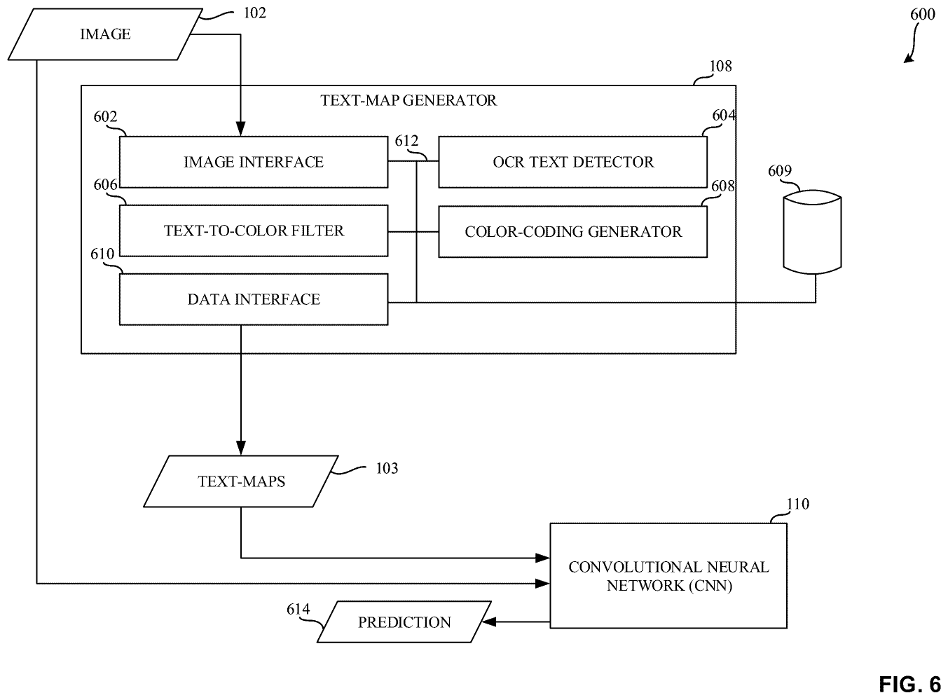

In the example of FIG. 1, the text-map generator 108 communicates with the image repository 106 to obtain one of the images 102. In FIG. 1, the obtained image is the food product label 102. In other examples disclosed herein, the obtained image may be any single one of, or plural ones of the images 102. The text-map generator 108 generates example text-maps 103 for use by the CNN 110. In examples disclosed herein, the text-maps 103 are color-coded text-map images that are visual representations of locations of text in the obtained image (e.g., the food product label 102). The operation of the text-map generator 108 will be explained in further detail in connection with FIG. 6 below.

In the example of FIG. 1, the CNN 110 communicates with the image repository 106 and the text map generator 108. The CNN 110 utilizes the text-maps 103 from the text-map generator in connection with the obtained image (e.g., the food product label 102) from the image repository 106 to generate an example result 112. The CNN 110 is a computer learning network that recognizes visual patterns in images. The CNN 110 may be implemented by any suitable neural network such as a region-convolutional neural network (RCNN), a fast region-convolutional neural network (Fast RCNN), etc.

In FIG. 1, the result 112 includes the text region of interest 114 and an example second region not of interest 116. In examples disclosed herein, the result 112 includes a set of probabilities including a probability representing the likelihood of the location of the text region of interest 114. In other examples disclosed herein, the result 112 includes a set of probabilities including a probability representing the likelihood of the location of the second region not of interest 116. In such an example, the second region not of interest 116 may have a corresponding probability and/or confidence score lower than the corresponding probability and/or confidence score associated with the text region of interest 114. In the example of FIG. 1, corresponding probability values (or confidence scores) of the text region of interest 114 and the second region not of interest 116 are shown as 0.91 and 0.42. For example, the confidence score of 0.91 corresponds to the text region of interest 114 and the confidence score of 0.42 corresponds to the second region not of interest 116. As such, the relatively higher confidence score of 0.91 indicates that the text region of interest 114 is more likely the text region of interest than the second region not of interest 116 corresponding to the relatively lower confidence score of 0.42.

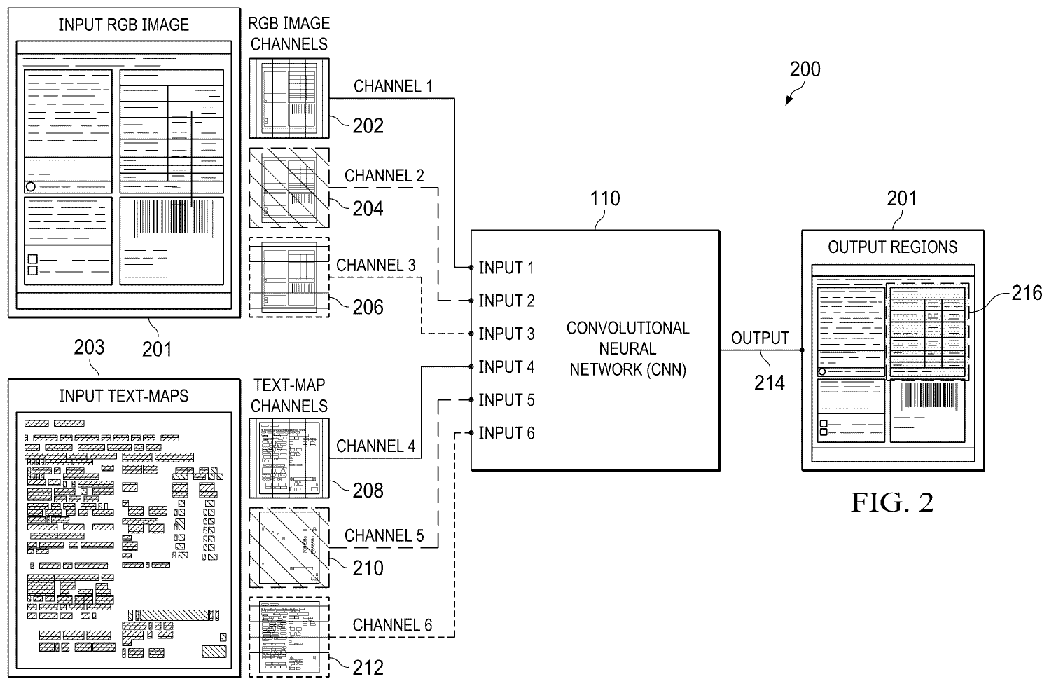

FIG. 2 is the example CNN 110 of FIG. 1 structured to receive and analyze input images, and to determine the locations of text regions of interest. An example implementation 200 of FIG. 2 includes an example nutritional image 201, example text-maps 203, and the CNN 110 of FIG. 1. The example CNN 110 includes a plurality of input channels including an example first input channel 202, an example second input channel 204, an example third input channel 206, an example fourth input channel 208, an example fifth input channel 210, and an example sixth input channel 212. The example CNN 110 also includes an example output channel 214. In other examples, the CNN 110 may include any number of input and/or output channels.

In the example of FIG. 2, after generating the text-maps 203 in accordance with teachings of this disclosure, the text-maps 203 are provided to the CNN 110. The example nutritional image 201 (e.g., the original image) is also provided to the CNN 110, and the CNN 110 analyzes the input images to detect an example text region of interest 216. In FIG. 2, the nutritional image 201 is separated into three color-component images of red, green, blue (RGB). The CNN 110 receives the nutritional image 201 as the three separate RGB color-component images using three RGB channels (e.g., the first input channel 202, the second input channel 204, and the third input channel 206). Also in the example of FIG. 2, the text-maps 203 include three color-component text-maps which are shown merely by way of example as overlaid on one another in FIG. 2. In implementation, the CNN 110 receives the text-maps 203 as the three separate color-component images using three text-map channels (e.g., the fourth input channel 208, the fifth input channel 210, and the sixth input channel 212). Each color-coded text-map provided to the text-map channels 208, 210, 212 highlights areas of text which satisfy respective text characteristics. Although three color-component channels are shown per input image in FIG. 2, fewer or more color-component channels may be used per input image in other examples. In addition, the colors of the text-map channels 208, 210, 212 need not be the same as the colors of the RGB channels.

The example CNN 110 is trained during a training phase to detect a particular type of text region of interest. Based on such training, the CNN 110 analyzes the color-coded-component inputs of the input images 201, 203 to detect features located therein, and generate probability outputs indicative of likelihoods that different corresponding text regions of the nutritional image 201 are a text region of interest. In the example of FIG. 2, in response to predicting the text region of interest 216 using the CNN 110, the implementation 200 may provide the text of the identified text region of interest (e.g., the ingredients list and/or nutritional facts) based on OCR text extraction.

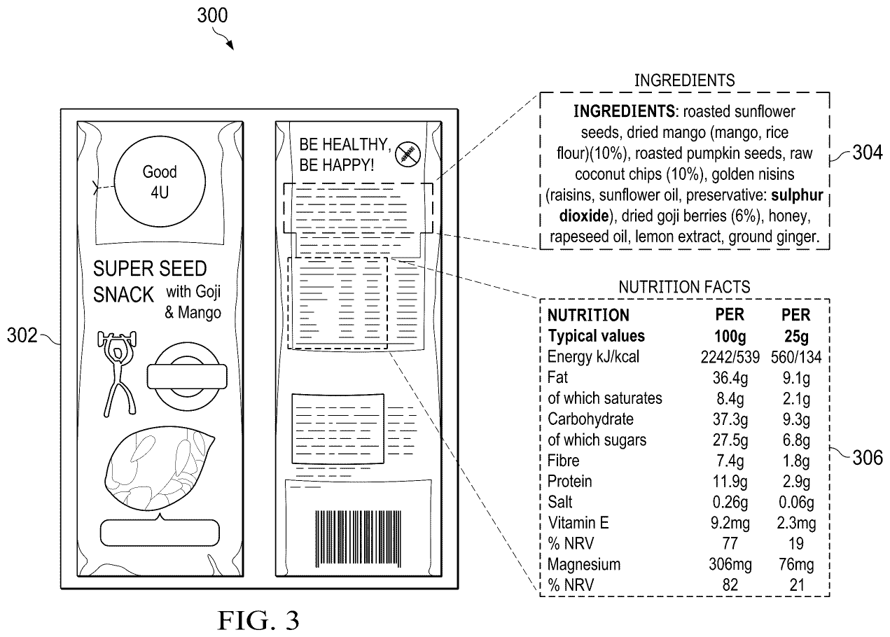

FIG. 3 is an illustration 300 of an example image 302 with multiple text regions to be analyzed by the CNN 110 of FIG. 1 based on color-component images as described above in connection with FIG. 2. In FIG. 3, the image 302 is a product label including an example first text region of interest 304 and an example second text region of interest 306. In illustration, the image 302 includes multiple views of the product label mentioned above (e.g., a front view and a back view). In the example of FIG. 3, the first text region of interest 304 and the second text region of interest 306 are illustrative of example results from the CNN 110 of FIG. 1 (e.g., the result 112 of FIG. 1). The first text region of interest 304 corresponds to the identified region of text in which an ingredients list appears. The second text region of interest 306 corresponds to the identified region of text in which nutritional facts appear. In such an example, the text-map generator 108 (FIG. 1) and the CNN 110 are used to identify the location in which the context of the ingredients list appears (e.g., the first text region of interest 304) and the location in which the context of nutritional facts appears (e.g., the second text region of interest 306).

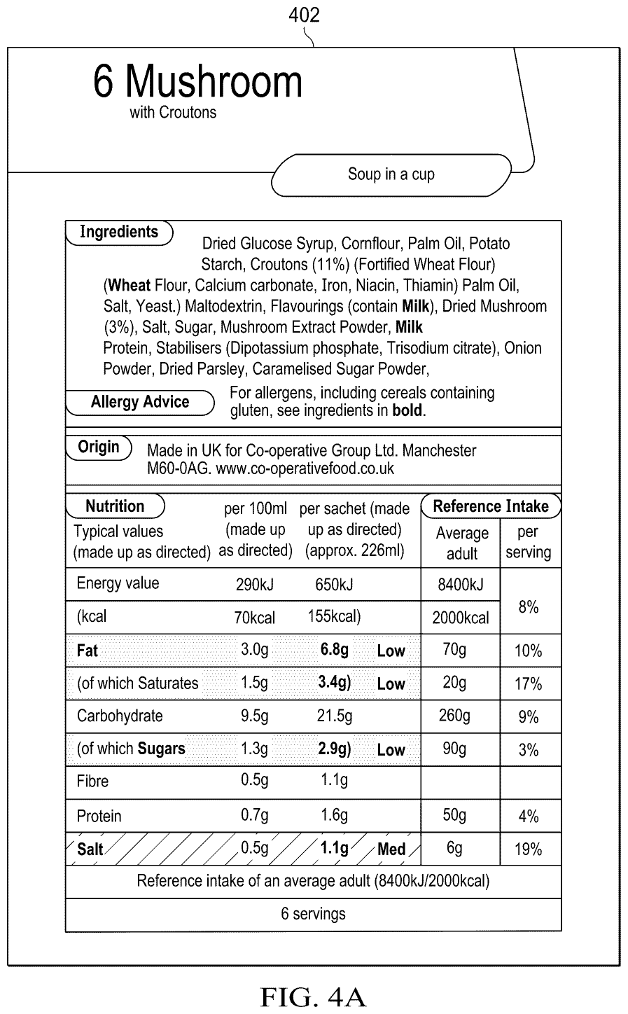

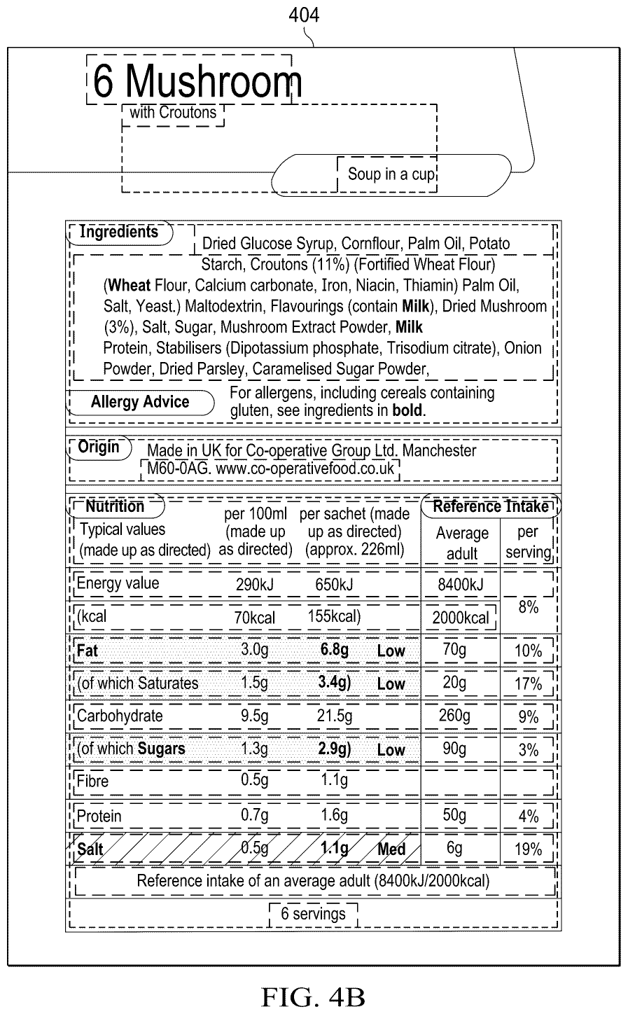

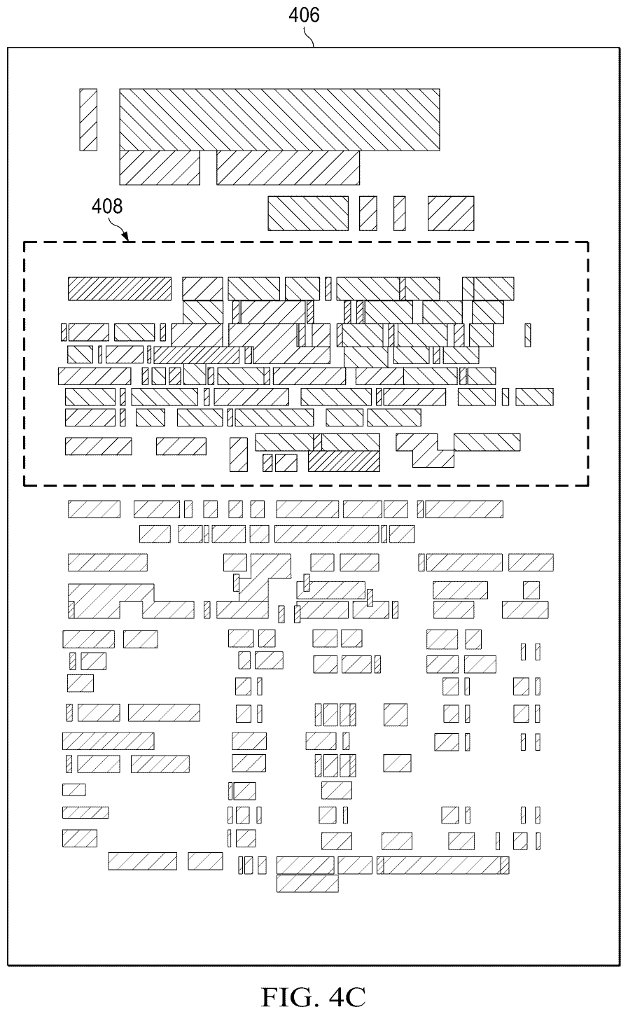

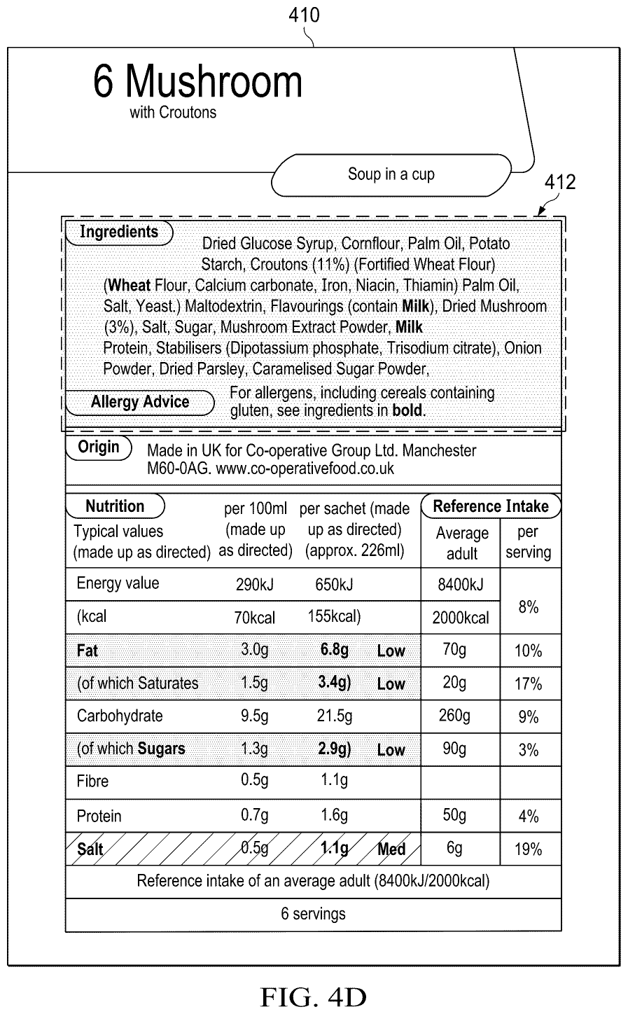

FIGS. 4A-4D depict an example image 402 as it is processed using examples disclosed herein to generate an example text-map 406 and determine a location of an example text region of interest 412. The examples of FIGS. 4A-4D show the image 402 at different stages of examples disclosed herein. For example, FIG. 4B is an example OCR-processed image of interest 404, FIG. 4C is the text-maps 406 including an example color-coded text region of interest 408, and FIG. 4D is an example result image 410 including a highlighting of the text region of interest 412.

In the example of FIGS. 4A-4D, the image 402 is a food product label including multiple contexts of text (e.g., an ingredients list, a nutrition facts table, a product description, etc.). The OCR-processed image of interest 404 (FIG. 4B) represents the resulting text extraction based on OCR analysis. In the OCR-processed image of interest 404, various text characters and/or words are identified for further analysis of the contexts in which the identified text characters and/or words are located.

In FIGS. 4A-4D, after the OCR analysis on the image 402 (e.g., the recognition of text in the OCR-processed image of interest 404), the text-maps 406 (FIG. 4C) are generated. In the example of FIGS. 4A-4D, the text-maps 406 are shown as an overlay of multiple color-coded text-maps (e.g., an overlay of a first color-coded text-map, a second color-coded text-map, and a third color-coded text-map) merely by way of example to show locations of different color-coded text locations relative to one another. For example, the word “milk” has a high probability of belonging to ingredients and, as such, the color-coded text region of interest 408 is colored in the text-map 406 with a relatively higher intensity than other words that are found in ingredients lists less often. In implementation, the text-maps 406 are separated and provided separately to the CNN 110, as described above in connection with FIG. 2. As such, the text-maps 406 are a visual representation including various colors corresponding to different text satisfying text characteristics corresponding to those color. In FIGS. 4A-4D, the color-coded text region of interest 408 corresponds to a desired context of text that includes an ingredients list.

In the example illustrated in FIG. 4D, the result image 410 includes a highlighted area identified by the CNN 110 as being the text region of interest 412. The text region of interest 412 represents the identified region and/or location corresponding to the intensely colored region in the text-map 406. In the example of FIGS. 4A-4D, the text region of interest 412 represents the detected ingredients list section.

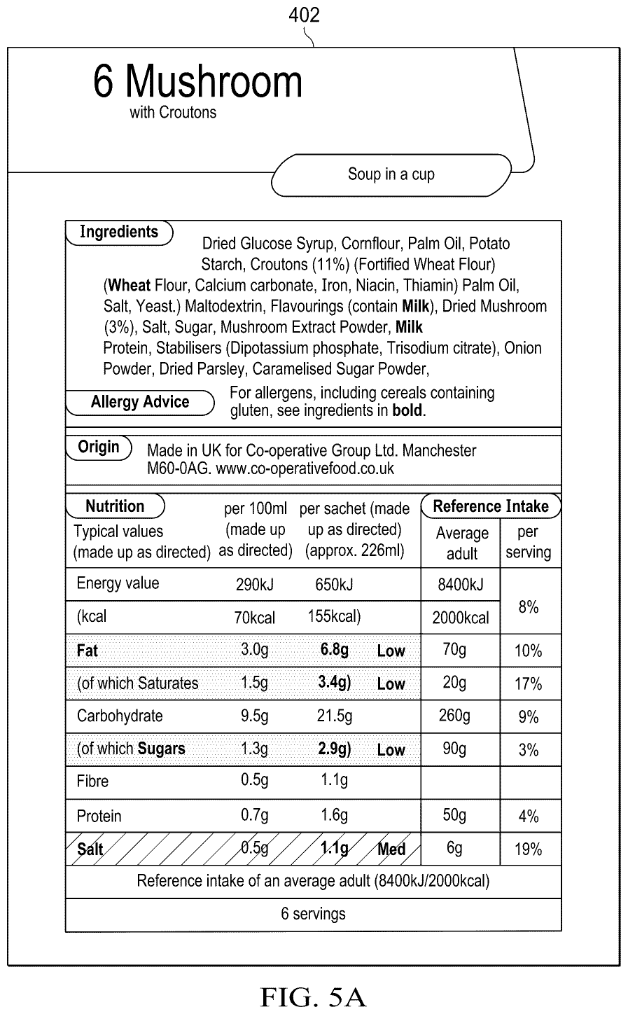

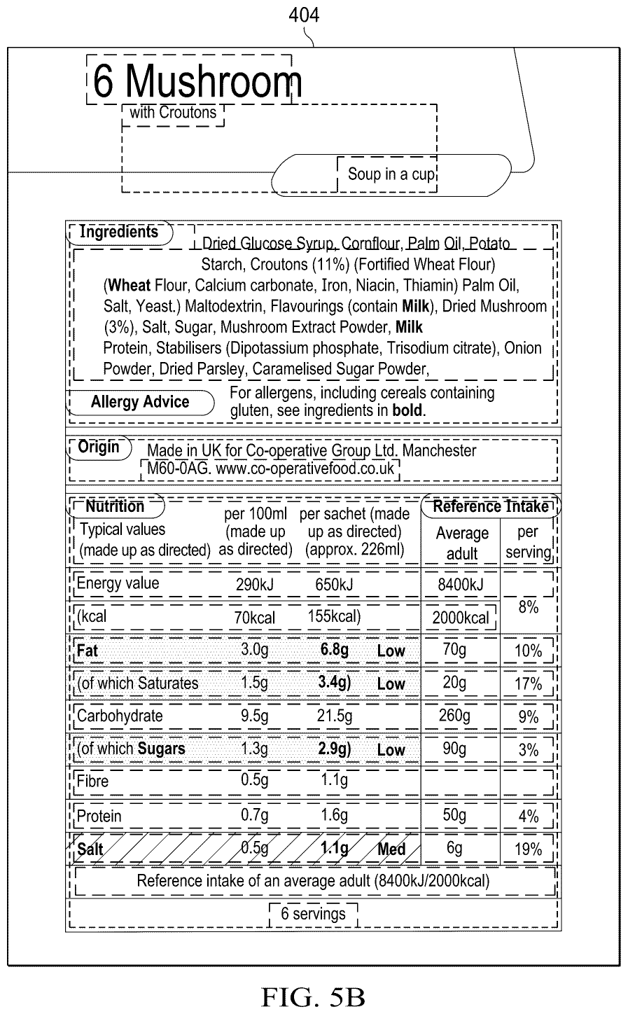

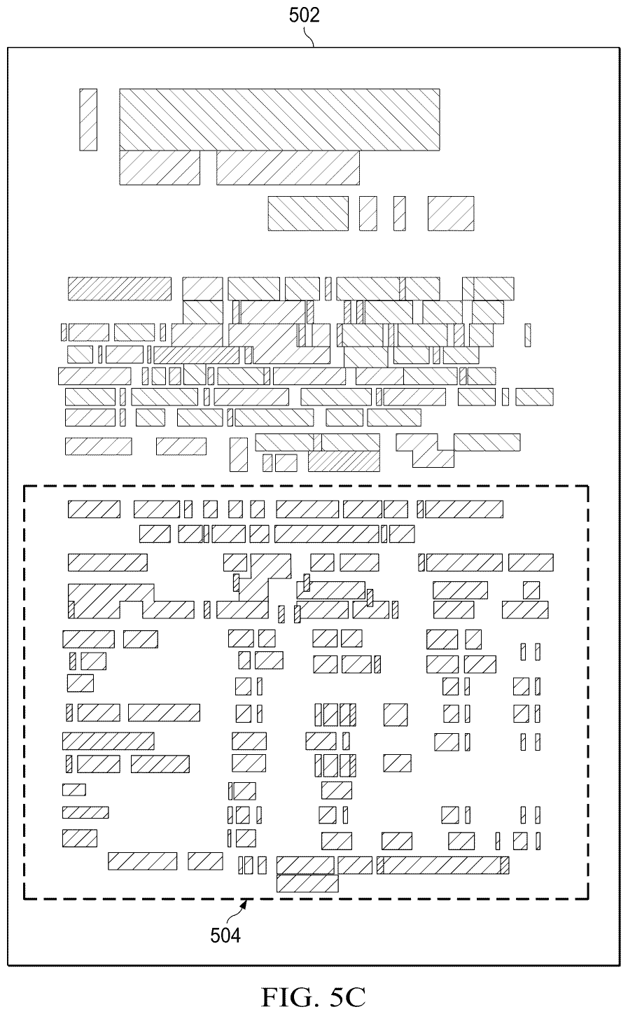

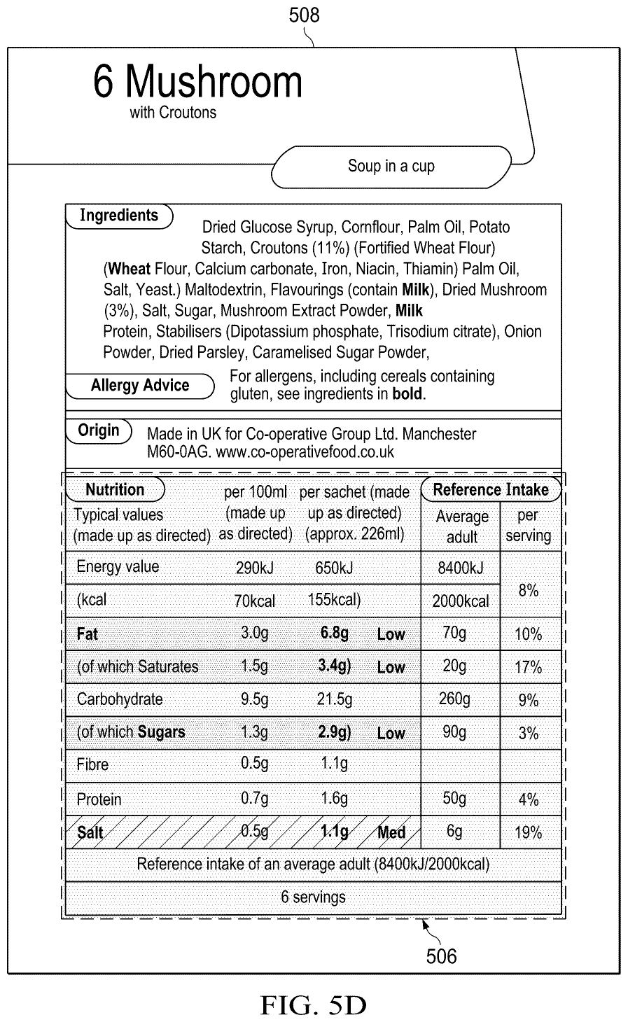

FIGS. 5A-5D depict the example image 402 of FIGS. 4A-4D in association with another example text-map 502 of FIG. 5C and another example text region of interest 506 of FIG. 5D. More specifically, FIG. 5A includes the image 402 of FIG. 4A, FIG. 5B includes the example OCR-processed image of interest 404 of FIG. 4B, FIG. 5C includes the text-maps 502 including an example second color-coded text region of interest 504, and FIG. 5D includes a highlighted text region of interest 506 and an example result image 508.

In the example of FIGS. 5A-5D, the image 402 is a food product label including multiple regions of text (e.g., an ingredients list, a nutrition facts table, a product description, etc.). As such, the OCR-processed image of interest 404 (FIG. 5B) represents the resulting extraction from OCR analysis. In the OCR-processed image of interest 404, various text characters and/or words are identified for further analysis of the context in which the identified text characters and/or words are located.

After the OCR analysis on the image 402 (e.g., the recognition of text in the OCR-processed image of interest 404), the example second text-maps 502 (FIG. 5B) are generated. The example second text-maps 502 are shown as an overlay of multiple color-coded text-maps (e.g., an overlay of a first color-coded text-map, a second color-coded text-map, and a third color-coded text-map) merely by way of example to show locations of different color-coded text locations relative to one another. For example, the word “protein” has a high probability of belonging to a nutrition facts table, and, as such, the second color-coded text region of interest 504 is colored in the second text-map 502 with a relatively higher intensity than other words that are found in nutrition facts tables less often. In implementation, the text-maps 406 are separated and provided separately to the CNN 110, as described above in connection with FIG. 2. As such, second text-maps 502 are a visual representation including various colors corresponding to different text satisfying text characteristics corresponding to those colors. In FIGS. 5A-5D, the second color-coded text region of interest 504 corresponds to a desired context of text that includes a nutrition facts table.

In the example of FIG. 5D, the result image 508 includes a highlighted area identified by the CNN 110 as being the text region of interest 506. The text region of interest 506 represents the identified region and/or location corresponding to an intensely colored region in the second text-map 502. In the example of FIG. 5D, the text region of interest 506 represents the nutritional facts section.

FIG. 6 is an example block diagram 600 of the text-map generator 108 in circuit with the CNN 110 of FIG. 1. The text-map generator 108 includes an example image interface 602, an example OCR text detector 604, an example text-to-color filter 606, an example color-coding generator 608, and an example data interface 610. In examples disclosed herein, an example communication bus 612 allows for communication between any of the image interface 602, the OCR text detector 604, the text-to-color filter 606, the color-coding generator 608, and/or the data interface 610. The communication bus 612 may be implemented using any suitable kind of communication bus.

In the example of FIG. 6, the image interface 602 obtains the image 102. For example, the image interface 602 communicates with the image repository 106 of FIG. 1 to obtain and/or otherwise retrieve the image 102. In some examples disclosed herein, the image 102 may be an image of any one of the items 101 of FIG. 1, or any other suitable image and/or readable file (e.g., a PDF file). In other examples disclosed herein, the image interface 602 may obtain images (e.g., training images) for use in training the CNN 110.

In the example of FIG. 6, the OCR text detector 604 communicates with the image interface 602 to perform OCR analysis on the image 102. In examples disclosed herein, the OCR text detector 604 extracts textual information from the image 102. For example, the OCR text detector 604 extracts all text characters and/or words from the image 102 for later use. In examples disclosed herein, the OCR text detector 604 converts text on the image 102 to machine-readable digital text. In some examples disclosed herein, the OCR text detector 604 may be implemented using any suitable logic circuit and/or machine-executable program suitable to convert text information on the image 102 into machine-readable digital text.

In the example of FIG. 6, the text-to-color filter 606 communicates with the OCR text detector 604 to obtain the image 102 in response to text-recognition being complete. The text-to-color filter 606 selects a text characteristic for use in analyzing the extracted text. Examples of such text analysis include a word occurrence ratio indicative of a number of occurrences of a word inside a text region of interest relative to total occurrences of the word in the entire image, punctuation signs, Bayesian distance between a word and a dictionary of keywords, etc. In examples disclosed herein, the text characteristic may be specified via user input and/or specified in a configuration file. In addition, the text-to-color filter 606 selects different colors to mark text satisfying corresponding text characteristics. In examples disclosed herein, the text-to-color filter 606 pairs a color with a corresponding text characteristic and transmits such paring to the color-coding generator 608.

In examples disclosed herein, the text-to-color filter 606 determines what extracted text of the image 102 satisfies different ones of the text characteristics (e.g., matches, satisfies a threshold, etc.). For example, a text characteristic may be punctuation such that any punctuation text satisfies the text characteristic. In such examples, the text-to-color filter 606 may determine the locations of all punctuation text on the image 102 and provides the locations to the color-coding generator 608 in association with the text characteristic. Furthermore, the text-to-color filter 606 may determine if the extracted text on the image 102 satisfies a second text characteristic. For example, the second text characteristic may specify that text must match words in a dictionary. In the example of FIG. 6, the dictionary is a custom-build dictionary that includes words found to be relevant to a particular context corresponding to a region of interest for which the CNN 110 is to search in the image 102. For example, if the image 102 is of a food product, and the region of interest is a nutrition facts table, the dictionary includes nutrition terms such as calories, carbohydrates, sodium, protein, sugar, etc. If the image 102 is a computer product webpage, and the region of interest is the specifications table, the dictionary includes technical terms typically used to describe technical specifications of computers. In the example of FIG. 6, an example text database 609 stores the dictionary or a plurality if dictionaries for different text contexts. In the example of FIG. 6, the text-to-color filter 606 compares the extracted text of the image 102 with the words appearing in the text database 609. In such examples, in response to the text-to-color filter 608 determining matches between the extracted text of the image 102 and one or more words in the text database 609 the text-to-color filter 606 determines the locations of the text satisfying the second characteristic and provides the locations to the color-coding generator 608. Likewise, the text-to-color filter 606 may reiterate the above process using different colors corresponding to different text characteristics. In examples disclosed herein, text location information generated by the text-to-color filter 606 is in the form of pixel coordinates defining the boundaries of text satisfying the different text characteristics. In other examples disclosed herein, the text database 609 may be implemented internal and/or external to the text-map generator 108.

In the example of FIG. 6, a third text characteristic can be a word occurrence ratio of a word in the image 102. In such examples, the example text-to-color filter 606 counts and/or otherwise records the number of times an extracted word from the image 102 appears in the text region of interest 114 relative to the occurrences of the word in the whole image 102. For example, the text-to-color filter 606 may determine and record a ratio representing a proportion and/or ratio of the total number of times the word “fiber” appears on a product label in the text region of interest 114 relative to in the whole image. For example, if the total number of times “fiber” appears in the whole image of a product label is 100, and the number times the word “fiber” appears in the text region of interest 114 is 10, then the text-to-color filter 606 records a ratio of 1:10 with respect to the word “fiber.” In another example, the text-to-color filter 606 may determine and record a percentage value representative of the number of times the word “fiber” appears in a whole image of a food product label relative to “fiber” appearing in the text region of interest 114 of the product label. For example, if the total number of times “fiber” appears in a whole image of a product label is 100 and the number times the word “fiber” appears in the text region of interest 114 of the product label is 10, then the text-to-color filter 606 records a percentage value of 10% for the word “fiber.” As yet another example text characteristic, the text-to-color filter 606 may record and/or otherwise indicate whether the word “fiber” appears more than an occurrence threshold (e.g., greater than five) in the text region of interest 114. The text-to-color filter 606 utilizes an example ratio, an example proportion, an example percentage, and/or an example occurrence threshold indicator to determine the location(s) of the text satisfying such criteria, and provides the location(s) to the color-coding generator 608.

In the example of FIG. 6, the color-coding generator 608 generates a plurality of color-coded text-maps 103 (FIG. 1) based on text location information from the text-to-color filter 606 and based on the text characteristic-to-color pairing from the text-to-color filter 606. In the example of FIG. 6, the color-coding generator 608 generates respective color-coded text-maps 103 for each respective text characteristic. For example, the color-coding generator 608 generates a plurality of color-coded text-map 103 images, the plurality of color-coded text-map images 103 including color-coded segments with different colors, the color-coded segments based on the text location information of text in the image 102 that satisfies the different text characteristics.

In addition, the color-coding generator 608 can color code using multiple levels of intensity. Such different color intensity levels can be based on how often particular text is known to appear in a particular context across different items relative to other text. For example, both water and apples may be in a dictionary of the text database 609 for the context of ingredients list. However, the term water may be marked with a higher intensity color shading than the term apples although both are marked with the same color. In such example, the reason for the higher intensity shading for water is that water is known to occur more often across ingredients lists than apples.

In the example of FIG. 6, the data interface 610 communicates with the color-coding generator 608 to obtain the generated color-coded text-maps 103. The data interface 610 provides the color-coded text-maps 103 to the CNN 110. If the text-map generator 108 is on a separate machine from the CNN 110, the data interface 610 may transmit the color-coded text-maps 103 to the CNN 110 via any suitable wired and/or wireless communication. If the text-map generator 108 and the CNN 110 are implemented on the same machine, the data interface 610 provides the color-coded text-maps 103 to the CNN 110 via a data bus or a function call or by storing the color-coded text-maps 103 in a memory location accessible by the CNN 110.

In FIG. 6, the CNN 110 processes the obtained color-coded text-maps 103 to generate an example prediction 614. In examples disclosed herein, the prediction 614 is the result of the CNN 110 generating probability values representative of likelihoods that different text regions of the input image 102 are the text region of interest selected to be identified by the CNN 110. For example, the CNN 110 can determine, utilizing the color-coded text-maps 103 and the image 102, the text region of interest on the image 102 and a region not of interest on the image 102. For example, the CNN 110 may identify a region not of interest as separate from the text region of interest even when a same keyword is determined to appear in both the text region of interest and the region that is not of interest. The prediction 614 is highly accurate because even though keywords may appear in different regions of text of an input image 102 (including in the text region of interest and in text regions not of interest), the text region of interest will have more relevancy-indicating color shading and higher color intensity usage corresponding to text located therein than other text regions of the input image 102. Such prediction 614 may be in the form of percentages representing the probability values.

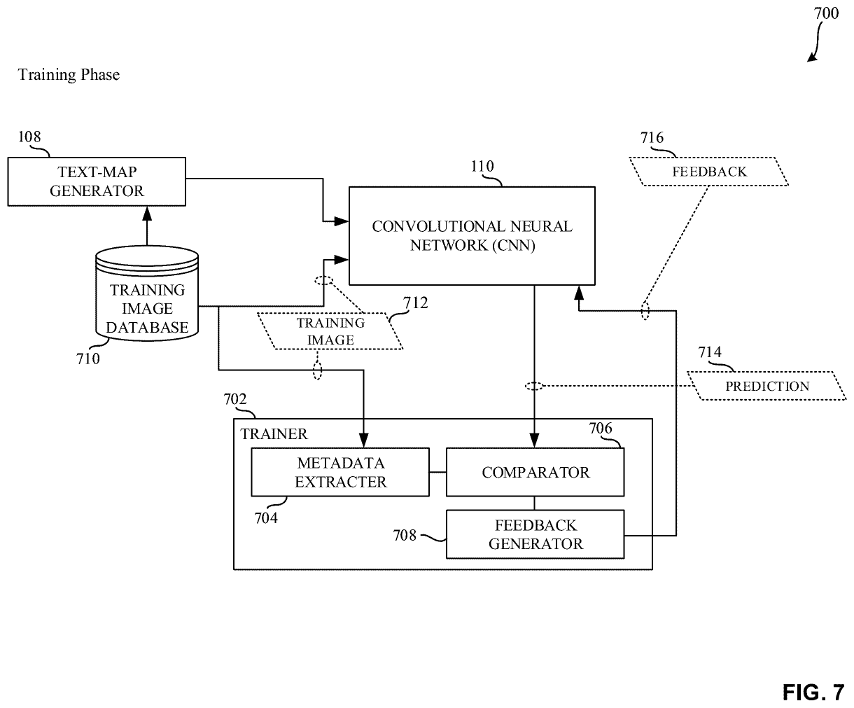

FIG. 7 is an example block diagram 700 of a trainer 702 in circuit with the CNN 110 of FIG. 1 to train the CNN 110 to determine locations of text regions of interest in images. The example trainer 702 includes an example metadata extracter 704, an example comparator 706, and an example feedback generator 708. In examples disclosed herein, the trainer 702 communicates with an example training images database 710 to obtain an example training image 712.

In the example of FIG. 7, the metadata extracter 704 determines whether the training image 712 is available. Additionally, the metadata extracter 704 obtains and/or otherwise retrieves the training image 712 and extracts metadata from the training image 712 as reference information to facilitate training of the CNN 110. In examples disclosed herein, the metadata extracter 704 extracts metadata indicative of the actual location (e.g., a training reference location) of the desired text context (e.g., the text region of interest) in the training image 712. The metadata extracter 704 provides the training reference location to the comparator 706. In other examples disclosed herein, the metadata extracter 704 may be implemented using any suitable residual neural network (ResNet) in connection with a convolutional neural network (e.g., the CNN 110 of FIG. 1). For example, the metadata extracter 704 may be a ResNet backbone including a learning rate, a weight decay, a dropout keep probability, a batch size, and/or an optimizer (e.g., an Adam optimizer) during ten epochs (e.g., one forward pass through the trainer 702 and one reverse pass through the trainer 702). In other examples disclosed herein, the metadata extracter 704 may be implemented using any suitable neural network training backbone.

In the example of FIG. 7, the comparator 706 obtains the training reference location of the desired text context (e.g., the text region of interest) from the metadata extracter 704, and obtains an example prediction value 714 produced by the CNN 110 of the predicted location of the desired text context (e.g., the text region of interest). The comparator 706 determines the difference between the prediction value 714 and the training reference location of the desired text context (e.g., the text region of interest). In examples disclosed herein, comparator 706 generates an error value representative of the difference between the prediction value 714 and the training reference location of the desired text context (e.g., the text region of interest).

In the example illustrated in FIG. 7, the feedback generator 708 communicates with the comparator 706 to obtain the generated error value. In examples disclosed herein, the feedback generator 708 provides the error value to the CNN 110 in the form of example feedback 716. In examples disclosed herein, the feedback generator 708 reformats and/or otherwise processes the error value from the comparator 706 to provide the feedback 716 to the CNN 110. As such, the CNN 110 utilizes the feedback 716 to modify its parameters to alter its prediction for future training images (e.g., a new training image from the training image database 710). In examples disclosed herein, the parameters of the CNN 110 refers to any suitable configuration variable in the CNN 110 (e.g., weights, etc.).

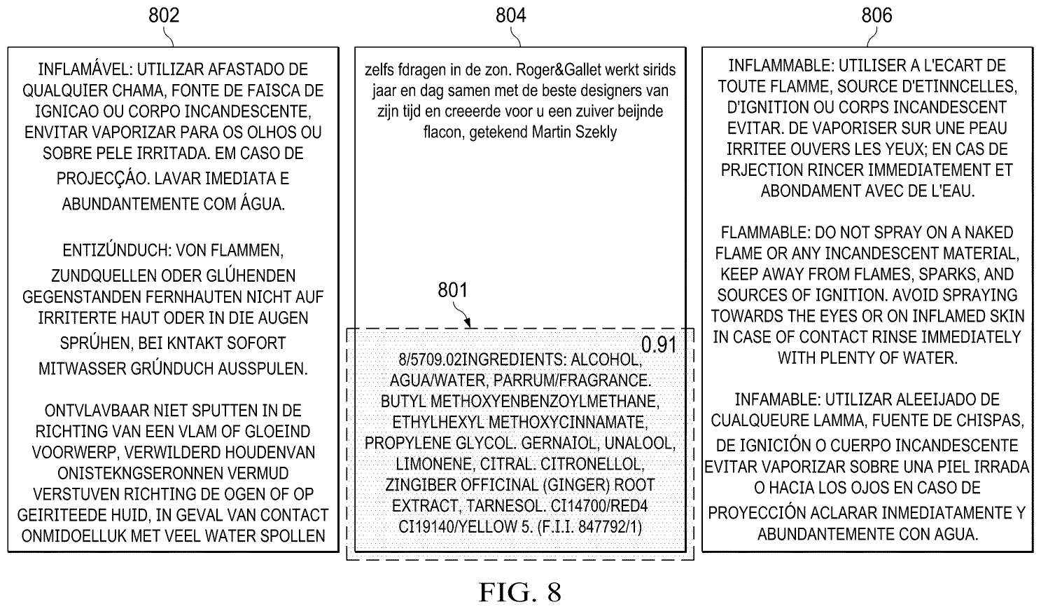

FIG. 8 depicts example images 802, 804, 806 and a text region of interest 801 identified by the CNN 110 of FIGS. 1, 2, 6, and 7 based on teachings of this disclosure. In the example of FIG. 8 the text region of interest 801 represent detection results from the CNN 110 of FIG. 1 utilizing the text-map generator 108 of FIG. 1.

In the example of FIG. 8, the first image 802, the second image 804, and the third image 806 include different sections of a product label or product packaging to be analyzed. The example of FIG. 8 illustrates the text region of interest 801 as being in the second image 804.

Additionally, the text region of interest 801 represents the prediction region located in the second image 804, along with an example prediction performance. In this example, the prediction performance is 0.91, or 91 percent. Illustrated in Table 1 below, the prediction performance when utilizing the text-map generator 108 with the CNN 110 of FIG. 1 is higher (e.g., more certainty) than when utilizing only a CNN (e.g., the CNN 110 of FIG. 1).

TABLE 1
Prediction Performance

| | CNN without text-maps | | | CNN with text-maps | | |
|---|---|---|---|---|---|---|
| | Precision | Recall | Accuracy | Precision | Recall | Accuracy |
| Ingredients | 0.25 | 0.31 | 0.15 | 0.70 | 0.73 | 0.56 |
| Nutritional | 0.34 | 0.57 | 0.27 | 0.72 | 0.81 | 0.62 |
| Facts | | | | | | |
| Totals | 0.29 | 0.44 | 0.21 | 0.71 | 0.77 | 0.59 |

In Table 1 above, the Precision represents a performance rate that is the relationship between true positives and the sum of true positives and false positives predicted by a CNN with respect to locations of text regions of interest, the Recall represents a rate that is the relationship between true positives and the sum of true positives and false negatives predicted by a CNN with respect to locations of text regions of interest, and Accuracy represents the overall performance (e.g., the relationship between true positives and the sum of true positives, false positives, and false negatives) of the CNN. As shown in Table 1 above, across two contexts of text (e.g., ingredients and nutritional facts), the CNN with text-maps (e.g., the CNN 110 utilizing the text-map generator 108) is more accurate than a CNN without text-maps.

While an example manner of implementing the text-map generator 108 of FIG. 1 is illustrated in FIGS. 6-7, one or more of the elements, processes and/or devices illustrated in FIGS. 6-7 may be combined, divided, re-arranged, omitted, eliminated and/or implemented in any other way. Further, the example image interface 602, the example OCR text detector 604, the example text-to-color filter 606, the example color-coding generator 608, the example data interface 610, and/or, more generally, the example text-map generator 108 of FIG. 1, and/or the example metadata extracter 704, the example comparator 706, the example feedback generator 708, and/or, more generally, the example trainer 702 of FIG. 7, and/or the example training image database 710 of FIG. 7, and/or the example CNN 110 of FIGS. 1, 2, 6 and/or 7 may be implemented by hardware, software, firmware and/or any combination of hardware, software and/or firmware. Thus, for example, any of the example image interface 602, the example OCR text detector 604, the example text-to-color filter 606, the example color-coding generator 608, the example data interface 610, and/or, more generally, the example text-map generator 108 of FIG. 1, and/or the example metadata extracter 704, the example comparator 706, the example feedback generator 708, and/or, more generally, the example trainer 702 of FIG. 7, and/or the example training image database 710 of FIG. 7, and/or the example CNN 110 of FIGS. 1, 2, 6 and/or 7 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example image interface 602, the example OCR text detector 604, the example text-to-color filter 606, the example color-coding generator 608, the example data interface 610, and/or, more generally, the example text-map generator 108 of FIG. 1, and/or the example metadata extracter 704, the example comparator 706, the example feedback generator 708, and/or, more generally, the example trainer 702 of FIG. 7, and/or the example training image database 710 of FIG. 7, and/or the example CNN 110 of FIGS. 1, 2, 6 and/or 7 is/are hereby expressly defined to include a non-transitory computer readable storage device or storage disk such as a memory, a digital versatile disk (DVD), a compact disk (CD), a Blu-ray disk, etc. including the software and/or firmware. Further still, the example text-map generator 108 of FIG. 1 may include one or more elements, processes and/or devices in addition to, or instead of, those illustrated in FIG. 6-7, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

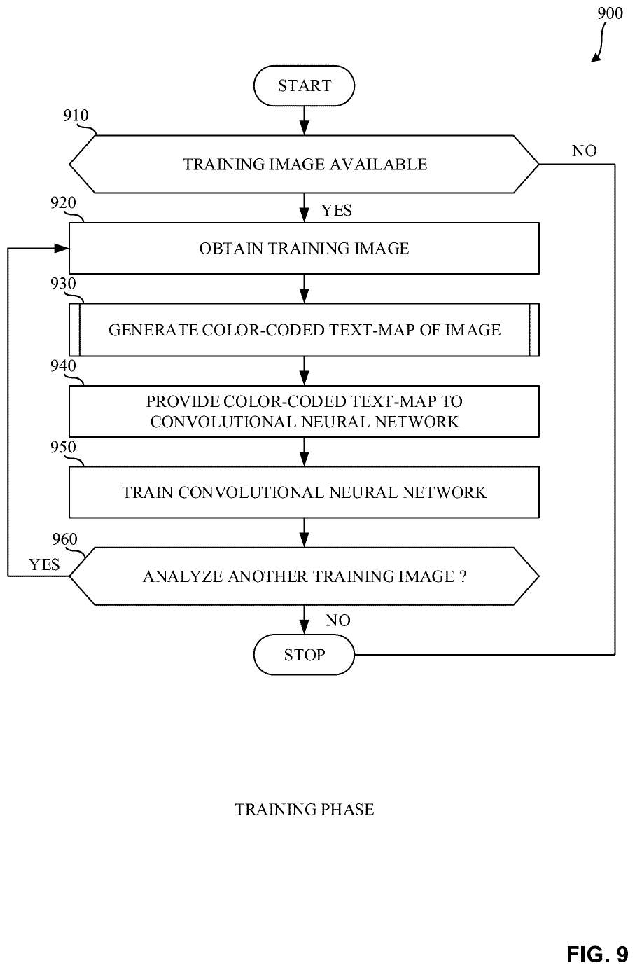

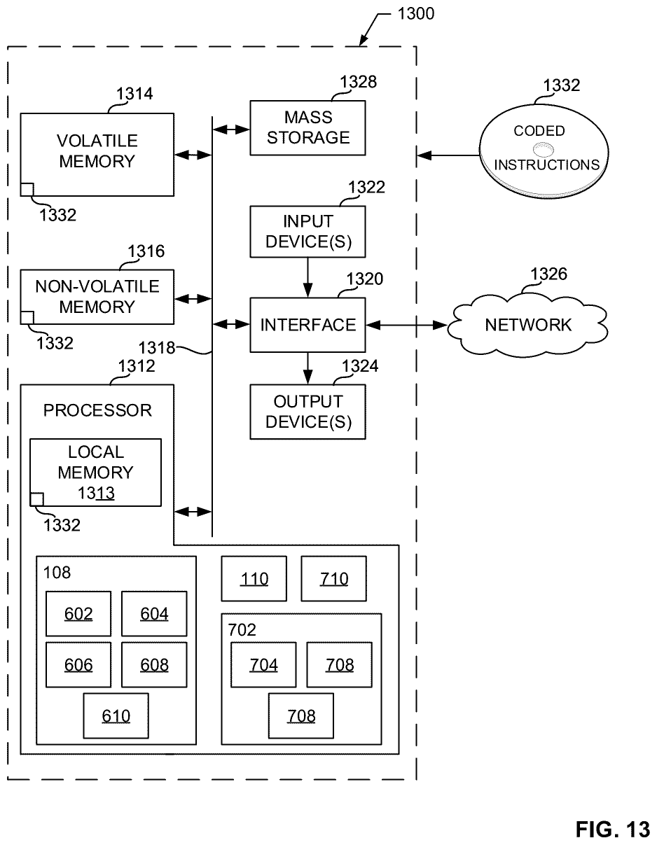

A flowchart representative of example hardware logic, machine readable instructions, hardware implemented state machines, and/or any combination thereof for implementing the text-map generator 108 of FIG. 1 is shown in FIGS. 6-7. The machine readable instructions may be one or more executable programs or portion(s) of an executable program for execution by a computer processor such as the processor 1312 shown in the example processor platform 1300 discussed below in connection with FIG. 13. The program may be embodied in software stored on a non-transitory computer readable storage medium such as a CD-ROM, a floppy disk, a hard drive, a DVD, a Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowcharts illustrated in FIGS. 9-12, many other methods of implementing the example text-map generator 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, etc. in order to make them directly readable and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein. In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

As mentioned above, the example processes of FIGS. 9-12 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A

FIG. 9 is a flowchart 900 representative of example machine readable instructions which may be executed to implement the trainer 702 of FIG. 7 to train the CNN 110 of FIGS. 1, 2, 6, and 7. The example image interface 602 determines whether a training image (e.g., the training image 712 of FIG. 7) is available (block 910). In other examples disclosed herein, the metadata extracter 704 may determine at block 910 whether a training image (e.g., the training image 712 of FIG. 7) is available. If a training image (e.g., the training image 712 of FIG. 7) is not available, the example process of FIG. 9 ends. Alternatively, in response to the control of block 910 indicating a training image (e.g., the training image 712 of FIG. 7) is available, the image interface 602 obtains the training image (e.g., the training image 712 of FIG. 7) (block 920). Additionally or alternatively, the metadata extracter 704 (FIG. 7) may obtain the training image (e.g., the training image 712 of FIG. 7) at block 920.

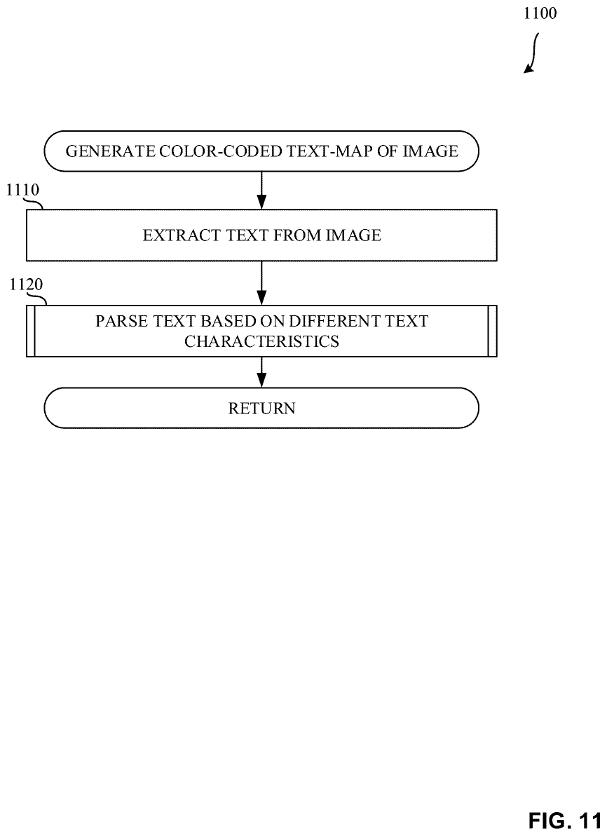

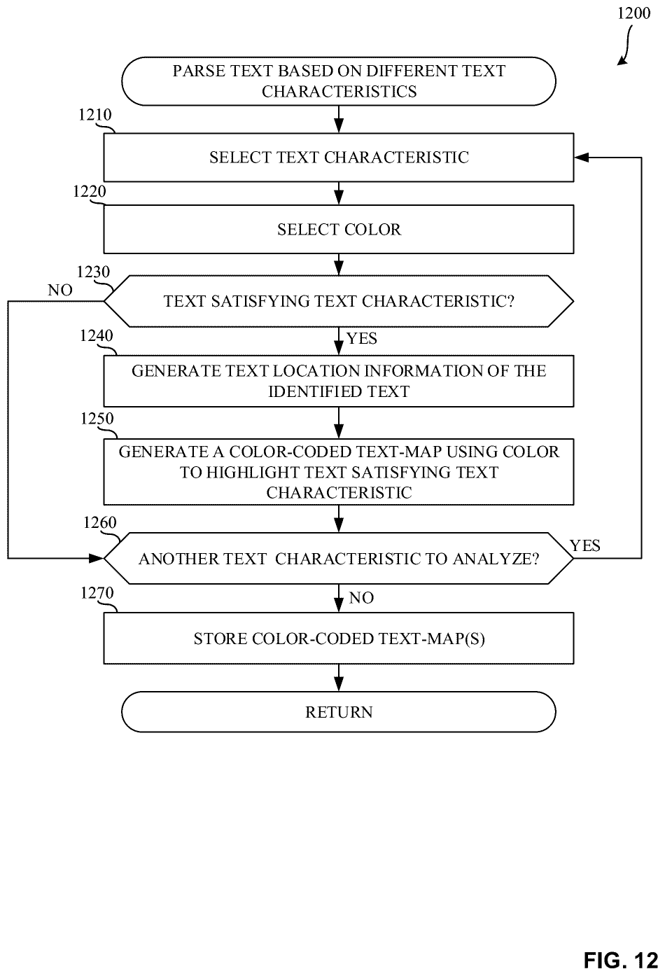

In response, the text-map generator 108 of FIG. 1 generates a color-coded text-map of the training image (e.g., the training image 712 of FIG. 7) (block 930). Example instructions that may be executed to implement block 930 are described below in connection with FIGS. 11 and 12. The data interface 610 of FIG. 6 provides the color-coded text-map to the CNN 110 (block 940). The trainer 702 trains the CNN 110 based on the color-coded text-map and the training image (e.g., the training image 712 of FIG. 7) (block 950). The trainer 702 determines whether to analyze another training image (block 960). If the trainer 702 determines to analyze another training image, control returns to block 920. Alternatively, if the trainer 702 determines to not analyze another training image, the example process of FIG. 9 stops. In examples disclosed herein, control ceases to operate in response to the comparator 706 and/or the feedback generator 708 determining that the CNN 110 is sufficiently trained by predicting a location of a text region of interest with a sufficient level of certainty. For example, the comparator 706 compares a prediction 714 (FIG. 7) from the CNN 110 with the actual location of a text region of interest from the metadata extractor 704. When the comparison confirms a sufficiently close match (e.g., within an error threshold), the feedback generator 708 confirms the CNN 110 is sufficiently trained.

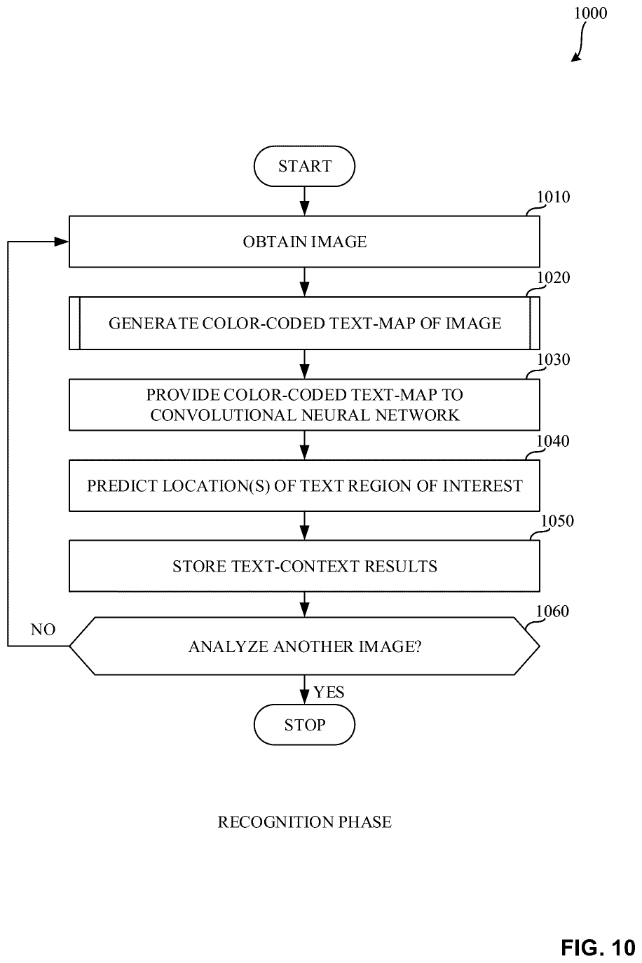

FIG. 10 is a flowchart 1000 representative of example machine readable instructions which may be executed to implement the text-map generator 108 and the CNN 110 of FIGS. 1, 2, 6, and 7 to determine location(s) of text regions of interest in images. The image interface 602 obtains an image (e.g., the image 102) (block 1010). In response, the text-map generator 108 generates a color-coded text-map of the image (block 1020). Example instructions that may be executed to implement block 1020 are described below in connection with FIGS. 11 and 12.

In the example of FIG. 10, the data interface 610 of FIG. 6 provides the color-coded text-map to the CNN 110 (block 1030). For example, the data interface 610 may send a plurality of color-coded text-maps to the CNN 110 or store the color-coded text maps in a memory accessibly by the CNN 110. In response, the CNN 110 predicts the location of the text region of interest (block 1040). For example, the CNN 110 may determine a first region in an image as more likely to be the first text region of interest than a second region in the image corresponding to the second text region that is not of interest based on performing CNN analysis on the image and the plurality of color-coded text-map images. Additionally, the CNN 110 stores the text-context results in memory (block 1050). The text-map generator 108 determines whether another image to analyze is available (block 1060). In response to determining another image to analyze is available, control returns to block 1010. Alternatively, if another image to analyze is not available, the example process of FIG. 10 ends.

FIG. 11 is a flowchart 1100 representative of example machine readable instructions which may be executed to implement the text-map generator 108 of FIGS. 1, 6, and 7 to generate color-coded text-maps 103 of an example image 102. In examples disclosed herein, the instructions represented by FIG. 11 may be executed to implement block 930 of FIG. 9 and/or block 1020 of FIG. 10. In FIG. 11, the OCR text detector 604 extracts the text from an image (e.g., the image 102 of FIG. 1) (block 1110). For example, the OCR text detector 604 may extract and/or generate text data from an image that includes a first text region of interest and a second text region not of interest.

At block 1120, the text-to-color filter 606 and the color-coding generator 608 of FIG. 6 parse text based on different text characteristics. Example instructions to execute block 1120 are described below in connection with FIG. 12. In response to completion of block 1120, control returns to a calling function or process such as a process implemented by the instructions represented by FIG. 9 and/or FIG. 10.

FIG. 12 is a flowchart 1200 representative of example machine readable instructions which may be executed to implement the color-coding generator 108 of FIG. 6 to parse text of an image and apply color coding based on different text characteristics. The instructions represented by FIG. 12 may be executed to implement block 1120 of FIG. 11. The text-to-color filter 606 selects a text characteristic to be analyzed (block 1210). For example, the text-to-color filter 606 may determine to analyze and/or otherwise identify the punctuation marks on the image (e.g., the image 102 of FIG. 6). In other examples disclosed herein, the text-to-color filer 606 may determine to analyze and/or otherwise identify the words on the image (e.g., the image 102 of FIG. 6) that match keywords in a dictionary. Another example text characteristic is the quantity of occurrences of text or a word in the image. In examples disclosed herein, the text-to-color filter 606 may select any suitable text characteristic.

The text-to-color filter 606 selects a corresponding color (block 1220). For example, for each selected text characteristic, the text-to-color filter 606 pairs an individual color. The text-to-color filter 606 determines text on the image that satisfies the text characteristic (block 1230). If the text-to-color filter 606 determines text that satisfies the text characteristic, the text-to-color filter 606 generates text location information of the identified text (block 1240). The color-coding generator 608 generates a color-coded text-map using color (e.g., the color selected in block 1220) to highlight the text satisfying the text characteristic (block 1250) based on the text location information from the text-to-color filter 606. For example, to execute block 1250, the color-coding generator 608 may generate a plurality of color-coded text-map images, the plurality of color-coded text-map images including color-coded segments with different colors, the color-coded segments corresponding to text having different text characteristics. If the color-coding generator 608 determines text in the image does not satisfy the text characteristic, or after creating the color-coded text-map at block 1250, the color-coding generator 608 determines whether another text characteristic is to be analyzed (block 1260).

If the color-coding generator 608 determines at block 1260 that another text characteristic is to be analyzed, then control returns to block 1210. Alternatively, if the color-coding generator 608 determines at block 1260 there is not another text characteristic to be analyzed, the color-coding generator 608 stores the generated color-coded text-map(s) in memory (block 1270). Control returns to a calling function or process such as the process implemented by the instructions represented by FIG. 11.

FIG. 13 is a block diagram of an example processing platform structured to execute the instructions of FIGS. 9-12 to implement the text-map generator 108 and/or the convolutional neural network 110 of FIGS. 1, 2, 6, and 7. The processor platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example image interface 602, the example OCR text detector 604, the example text-to-color filter 606, the example color-coding generator 608, the example data interface 610, and/or, more generally, the example text-map generator 108 of FIG. 1, and/or the example metadata extracter 704, the example comparator 706, the example feedback generator 708, and/or, more generally, the example trainer 702 of FIG. 7, and/or the example training image database 710 of FIG. 7, and/or the example CNN 110 of FIGS. 1, 2, 6, and/or 7.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), a Bluetooth® interface, a near field communication (NFC) interface, and/or a PCI express interface.

In the illustrated example, one or more input devices 1322 are connected to the interface circuit 1320. The input device(s) 1322 permit(s) a user to enter data and/or commands into the processor 1012. The input device(s) can be implemented by, for example, a camera (still or video), a keyboard, a button, a mouse, a touchscreen, a track-pad, a trackball, and/or isopoint system.

One or more output devices 1324 are also connected to the interface circuit 1320 of the illustrated example. The output devices 1024 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1320 of the illustrated example, thus, typically includes a graphics driver card, a graphics driver chip and/or a graphics driver processor.

The interface circuit 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1326. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, redundant array of independent disks (RAID) systems, and digital versatile disk (DVD) drives.

Machine executable instructions 1332 represented by the flowcharts of FIGS. 9-12 may be stored in the mass storage device 1328, in the volatile memory 1314, in the non-volatile memory 1316, and/or on a removable non-transitory computer readable storage medium such as a CD or DVD.

From the foregoing, it will be appreciated that example methods, apparatus and articles of manufacture have been disclosed that improve a computers accuracy in predicting text regions of interest in images including text characters and/or words using a convolutional neural network. The disclosed methods, apparatus and articles of manufacture increase the efficiency and accuracy of a computing device in detecting context of text by utilizing a plurality of color-coded text-maps generated by a text map generator to detect context of text using a convolutional neural network. The example disclosed methods, apparatus and articles of manufacture improve the efficiency of using a computing device by automatically identifying data relating to context of textual information in images. The example disclosed methods, apparatus and articles of manufacture are accordingly directed to one or more improvement(s) in the functioning of a computer.

Example methods, apparatus, systems, and articles of manufacture to detect a text region of interest in a digital image using machine-based analysis are disclosed herein. Further examples and combinations thereof include the following:

Example 1 includes an apparatus to analyze characteristics of text of interest, the apparatus comprising a text detector to provide text data from a first image, the first image including a first text region of interest and a second text region not of interest, a color-coding generator to generate a plurality of color-coded text-map images, the plurality of color-coded text-map images including color-coded segments with different colors, the color-coded segments corresponding to different text characteristics, and a convolutional neural network (CNN) to determine a first location in the first image as more likely to be the first text region of interest than a second location in the first image corresponding to the second text region that is not of interest based on performing a CNN analysis on the first image and the plurality of color-coded text-map images.

Example 2 includes the apparatus of example 1, wherein the plurality of color-coded text-map images includes a first color-coded text-map image and a second color-coded text-map image, the first color-coded text-map image including first color-coded segments of a first color, and the second color-coded text-map image including second color-coded segments of a second color.

Example 3 includes the apparatus of example 2, wherein the first color-coded segments correspond to a first text characteristic, and the second color-coded segments correspond to a second text characteristic.

Example 4 includes the apparatus of example 3, wherein the first color is different than the second color.

Example 5 includes the apparatus of example 1, wherein the CNN analysis identifies the second text region that is not of interest as separate from the first text region of interest when a same keyword appears in both the first text region of interest and the second text region that is not of interest.

Example 6 includes the apparatus of example 1, further including an interface to provide the plurality of color-coded text-map images to the CNN via a plurality of corresponding input channels of the CNN.

Example 7 includes the apparatus of example 1, wherein the first image is at least one of a food product label, a non-food product label, a sales receipt, a webpage, or a ticket.

Example 8 includes the apparatus of example 1, wherein the first text region of interest includes at least one of a nutrition facts table, a list of ingredients, a product description, candidate persons, numerical dates, or percentages.

Example 9 includes a non-transitory computer readable medium comprising computer readable instructions which, when executed, cause at least one processor to at least generate text data from a first image, the first image including a first text region of interest and a second text region not of interest, generate a plurality of color-coded text-map images, the plurality of color-coded text-map images including color-coded segments with different colors, the color-coded segments corresponding to different text characteristics, and determine a first location in the first image as more likely to be the first text region of interest than a second location in the first image corresponding to the second text region that is not of interest based on performing a CNN analysis on the first image and the plurality of color-coded text-map images.

Example 10 includes the computer readable medium of example 9, wherein the plurality of color-coded text-map images includes a first color-coded text-map image and a second color-coded text-map image, the first color-coded text-map image including first color-coded segments of a first color, and the second color-coded text-map image including second color-coded segments of a second color.

Example 11 includes the computer readable medium of example 10, wherein the first color-coded segments correspond to a first text characteristic, and the second color-coded segments correspond to a second text characteristic.

Example 12 includes the computer readable medium of example 11, wherein the first color is different than the second color.

Example 13 includes the computer readable medium of example 9, further including the at least one processor to identify the second text region that is not of interest as separate from the first text region of interest when a same keyword appears in both the first text region of interest and the second text region that is not of interest.

Example 14 includes the computer readable medium of example 9, further including the at least one processor to provide the plurality of color-coded text-map images to a CNN via a plurality of corresponding input channels of the CNN.

Example 15 includes the computer readable medium of example 9, wherein the first image is at least one of a food product label, a non-food product label, a sales receipt, a webpage, or a ticket.

Example 16 includes the computer readable medium of example 9, wherein the first text region of interest includes at least one of a nutrition facts table, a list of ingredients, a product description, candidate persons, numerical dates, or percentages.

Example 17 includes a method to analyze characteristics of text of interest, the method comprising generating text data from a first image, the first image including a first text region of interest and a second text region not of interest, generating a plurality of color-coded text-map images, the plurality of color-coded text-map images including color-coded segments with different colors, the color-coded segments corresponding to different text characteristics, and determining a first location in the first image as more likely to be the first text region of interest than a second location in the first image corresponding to the second text region that is not of interest based on performing a CNN analysis on the first image and the plurality of color-coded text-map images.

Example 18 includes the method of example 17, wherein the plurality of color-coded text-map images includes a first color-coded text-map image and a second color-coded text-map image, the first color-coded text-map image including first color-coded segments of a first color, and the second color-coded text-map image including second color-coded segments of a second color.

Example 19 includes the method of example 18, wherein the first color-coded segments correspond to a first text characteristic, and the second color-coded segments correspond to a second text characteristic.

Example 20 includes the method of example 19, wherein the first color is different than the second color.

Example 21 includes the method of example 17, further including identifying the second text region that is not of interest as separate from the first text region of interest when a same keyword appears in both the first text region of interest and the second text region that is not of interest.

Example 22 includes the method of example 17, further including providing the plurality of color-coded text-map images to the CNN via a plurality of corresponding input channels of the CNN.

Example 23 includes the method of example 17, wherein the first image is at least one of a food product label, a non-food product label, a sales receipt, a webpage, or a ticket.

Example 24 includes the method of example 17, wherein the first text region of interest includes at least one of a nutrition facts table, a list of ingredients, a product description, candidate persons, numerical dates, or percentages.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1-24. (canceled)

25. An apparatus comprising:
interface circuitry to obtain an image;
machine-readable instructions; and
at least one processor circuit to be programmed by the machine-readable instructions to:
generate a first text map to represent the image based on text regions extracted from the image, the first text map including (a) first locations having a first color, the first locations based on first ones of the text regions that include a first text characteristic; and (b) second locations associated with a second color that is different than the first color, the second locations based on second ones of the text regions that include a second text characteristic
execute a convolutional neural network (CNN) model based on the image and the first text map to detect a first region and a second region;
select the first region as corresponding to a first text context based on a comparison of a first probability value associated with the first region and a second probability value associated with the second region; and
generate a first bounding box on the image based on the first region.

26. The apparatus of claim 25, wherein one or more of the at least one processor circuit is to generate the first text map based on a text-to-color filter that assigns the first color to the first text characteristic and the second color to the second text characteristic.

27. The apparatus of claim 26, wherein one or more of the at least one processor circuit is to apply the text-to-color filter to the image to identify the first ones of the text regions and the second ones of the text regions.

28. The apparatus of claim 25, wherein the first text characteristic is based on at least one of a punctuation mark, a numeral, or a word satisfying a condition.

29. The apparatus of claim 25, wherein respective ones of the text regions include one or more characters and pixel coordinates defining a boundary of the one or more characters.

30. The apparatus of claim 25, wherein one or more of the at least one processor circuit is to:
generate a second text map to represent the image based on the text regions extracted from the image, the second text map including (a) third locations having a third color, the third locations based on third ones of the text regions that include a third text characteristic;
and (b) fourth locations having a fourth color that is different than the first, second, and third colors, the fourth locations based on fourth ones of the text regions that include a fourth text characteristic
execute a convolutional neural network (CNN) model based on the image and the second text map to detect a third region;
select the third region as corresponding to a second text context based on a third probability value associated with the third region, the second text context different than the first text context; and
generate a second bounding box on the image based on the third region.

31. The apparatus of claim 30, wherein at least one of the first ones of the text regions includes a first word and first coordinates, and at least one of the third ones of the text regions includes the first word and second coordinates that are different than the first coordinates.

32. The apparatus of claim 25, wherein one or more of the at least one processor circuit is to:
iteratively train the CNN model by:
executing the CNN model based on a training image and a training text map corresponding to the training image to generate an output, the output including a training location; and
comparing the training location with a ground-truth location associated with the training image to generate an error value indicative of an accuracy of the CNN model; and
determine that the CNN model is trained based on the error value satisfying an error threshold.

33. At least one non-transitory machine-readable medium comprising machine-readable instructions to cause at least one processor circuit to at least:
generate a first text map to represent an image of a document based on text regions extracted from the image of the document, the first text map including (a) first locations associated with a first color, the first locations based on first ones of the text regions that include a first text character trait; and (b) second locations associated with a second color that is different than the first color, the second locations based on second ones of the text regions that include a second text character trait;
execute a convolutional neural network (CNN) model based on the image of the document and the first text map to detect a first region and a second region;
select the first region as corresponding to a first text context based on a comparison of a first probability value associated with the first region and a second probability value associated with the second region; and
generate a first bounding box on the image of the document based on the first region.

34. The at least one non-transitory machine-readable medium of claim 33, wherein the machine-readable instructions are to cause one or more of the at least one processor circuit to generate the first text map based on a text-to-color filter that assigns the first color to the first text character trait and the second color to the second text character trait.

35. The at least one non-transitory machine-readable medium of claim 34, wherein the machine-readable instructions are to cause one or more of the at least one processor circuit to apply the text-to-color filter to the image of the document to identify the first ones of the text regions and the second ones of the text regions.

36. The at least one non-transitory machine-readable medium of claim 33, wherein the first text character trait is based on at least one of a punctuation mark, a numeral, or a word satisfying a condition.

37. The at least one non-transitory machine-readable medium of claim 33, wherein respective ones of the text regions include one or more characters and pixel coordinates defining a boundary of the one or more characters.

38. The at least one non-transitory machine-readable medium of claim 33, wherein the machine-readable instructions are to cause one or more of the at least one processor circuit to:
generate a second text map to represent the image of the document based on the text regions extracted from the image of the document, the second text map including (a) third locations associated with a third color, the third locations based on third ones of the text regions that include a third text character trait; and (b) fourth locations associated with a fourth color that is different than the first, second, and third colors, the fourth locations based on fourth ones of the text regions that include a fourth text character trait
execute a convolutional neural network (CNN) model based on the image of the document and the second text map to detect a third region;
select the third region as corresponding to a second text context based on a third probability value associated with the third region, the second text context different than the first text context; and
generate a second bounding box on the image of the document based on the third region.

39. The at least one non-transitory machine-readable medium of claim 38, wherein at least one of the first ones of the text regions includes a first word and first coordinates, and at least one of the third ones of the text regions includes the first word and second coordinates that are different than the first coordinates.

40. The at least one non-transitory machine-readable medium of claim 33, wherein the machine-readable instructions are to cause one or more of the at least one processor circuit to:
iteratively train the CNN model by:
executing the CNN model based on a training image and a training text map corresponding to the training image to generate an output, the output including a training location; and
comparing the training location with a ground-truth location associated with the training image to generate an error value indicative of an accuracy of the CNN model; and
determine that the CNN model is trained based on the error value satisfying an error threshold.

41. An apparatus comprising:
means for storing to store machine-readable instructions; and
means for processing to be programmed by the machine-readable instructions to:
generate a first text map to represent an image based on text regions extracted from the image, the first text map including (a) first areas associated with a first color, the first areas based on first ones of the text regions that include a first text characteristic; and (b) second areas associated with a second color that is different than the first color, the second areas based on second ones of the text regions that include a second text characteristic
execute a convolutional neural network (CNN) model based on the image and the first text map to detect a first region and a second region;
select the first region as corresponding to a first context based on a comparison of a first probability value associated with the first region and a second probability value associated with the second region; and
generate a first bounding box on the image based on the first region.

42. The apparatus of claim 41, wherein the means for processing is to:
generate a text-to-color filter that assigns the first color to the first text characteristic and the second color to the second text characteristic; and
apply the text-to-color filter to the image to identify the first ones of the text regions and the second ones of the text regions.

43. The apparatus of claim 41, wherein respective ones of the text regions include one or more characters and pixel coordinates defining a boundary of the one or more characters.

44. The apparatus of claim 41, wherein the means for processing is to:
generate a second text map to represent the image based on the text regions extracted from the image, the second text map including (a) third areas associated with a third color, the third areas based on third ones of the text regions that include a third text characteristic;
and (b) fourth areas associated with a fourth color that is different than the first, second, and third colors, the fourth areas based on fourth ones of the text regions that include a fourth text characteristic
execute a convolutional neural network (CNN) model based on the image and the second text map to detect a third region;
select the third region as corresponding to a second context based on a third probability value associated with the third region, the second context different than the first context; and
generate a second bounding box on the image based on the third region.
